(19) United States
(12) Patent Application Publication
(10) Pub. No.: US 2003/0204538 A1
(43) Pub. Date: Oct. 30, 2003

(54) Project management system

(76) Inventor: David Antony Keene, London (GB)

Correspondence Address: SWIDLER BERLIN SHEREFF FRIEDMAN, LLP, 3000 K STREET, NW, BOX IP, WASHINGTON, DC, 20007, US

(21) Appl. No.: 10/323,942

(22) Filed: Dec. 20, 2002

(30) Foreign Application Priority Data
Apr. 26, 2002 (GB) 0209648.5

(51) Int. Cl. G06F 17/30; G06F 12/00

(52) U.S. Cl. 707/203

(57) ABSTRACT

A project management system comprises a database for storing objects relating to a project together with data defining interdependencies of the objects. A control system responsive to entities connected to it provides access to selected objects stored on the database and stores on the database updated versions of selected objects received from the entities. The control system is adapted to notify, in response to an activity on an object, all entities handling that object or other objects dependent on that object of the existence of the activity.

### FIELD OF THE INVENTION

This invention relates to a project management system and an associated method.

### BACKGROUND TO THE INVENTION

It is common to store objects relating to a project on a central database such that they can be accessed easily by members of staff working on the project. For example, the objects may be project documentation or, in the case of a software project, the objects may be the individual source code files which make up the software.

Often, these objects are interdependent and hence, modifications made to one object may have an effect on dependent objects. In current systems, if an object is accessed by one member of staff, then other members of staff may access the same object which could lead to confusion and conflict with respect to modifications to that object. However, at present there is no real-time mechanism for indicating to members of staff that an object which is interdependent with one on which they are currently working has been accessed or modified by another member of staff. As such, changes may be made to one object which will have an effect on dependent objects without the members of staff working on those dependent objects being made aware of these changes.

### SUMMARY OF THE INVENTION

In accordance with one aspect of the present invention there is provided a project management system comprising a database for storing objects relating to a project together with data defining interdependencies of the objects; and a control system responsive to entities connected to it to provide access to selected objects stored on the database and to store on the database updated versions of selected objects received from the entities characterised in that the control system is adapted to notify, in response to an activity on an object, all entities handling that object or other objects dependent on that object of the existence of the activity.

In accordance with a second aspect of the present invention there is a project management method comprising storing, on a database, objects relating to a project together with data defining interdependencies of the objects; responding to entities connected to a control system to provide access to selected objects stored on the database and to store on the database updated versions of selected objects received from the entities characterised in that, in response to an activity on an object, all entities handling that object or other objects dependent on that object are notified of the existence of the activity.

Hence, the invention provides a project management system and method which allow entities to access objects stored on a database and to store updated versions of the objects on the database and which provide notification of an activity on an object to all entities handling other objects dependent on that object.

Normally, these entities will be workstations, users or services.

Typically, this activity comprises one or more of:

a) accessing the object; or

b) storing an updated version of the object.

The data defining interdependencies of the objects may be stored in a separate index or table. However, it is preferable for the data defining interdependencies of the objects to be stored with the objects themselves.

Typically, the control system maintains a register linking the objects with the entities handling them such that it can determine which entities to notify in response to an activity on an object.

Normally, the control system can prevent access to certain objects and, it will typically prevent access to objects that have been accessed and for which updated versions have not yet been stored on the database.

The control system will typically be an application server or other such framework.

Normally, the entities are connected to the database via a network, for example a local area network, and in a preferred example, the network is the Internet.

In the case where the entities are connected to the database via a network or the Internet, the entities typically communicate with the control system using browser software. This browser software may be configured to transfer several objects consecutively between the database and the entity and it will normally be configured to do this using an applet downloaded from the control system. Typically, objects are transferred using the File Transfer Protocol (FTP) or the Hypertext Transfer Protocol (HTTP).

Preferably, each object stored on the database will have a size attribute indicating its size in bytes, a date attribute indicating the date it was last modified and a time attribute indicating the time of day it was last modified. An object previously transferred from the database to the workstation will normally only be transferred back to the database if the size, date or time attributes of the object differ from those of a copy of the object stored in the database.

The project management system may also prevent objects from being mislaid if the browser software is further configured, upon transfer of an object from the entity to the database, to extract from the object the data defining interdependencies of the objects and to display a message on the entity requesting missing objects if there are any. Typically, the browser software will be configured to do this via the applet downloaded from the control systems.

The invention will typically be provided as a computer program comprising computer program code means adapted to perform all the steps of the second aspect of the invention when said program is run on a computer.

Further, there may be provided a computer program product comprising program code means stored on a computer readable medium for performing a method according to the second aspect of the invention when said program product is run on the computer.

### BRIEF DESCRIPTION OF THE DRAWINGS

An example of the invention will now be described, with reference to the accompanying drawings, in which:

FIG. 1 shows the architecture of the project management system;

FIG. 2 shows an example of how an object may be stored on the database;

FIG. 3 shows, by way of example, the hierarchy of objects stored on the database; and

FIG. 4 shows a register linking the objects stored on the database with the workstation that has downloaded them.

### DESCRIPTION OF THE EMBODIMENT

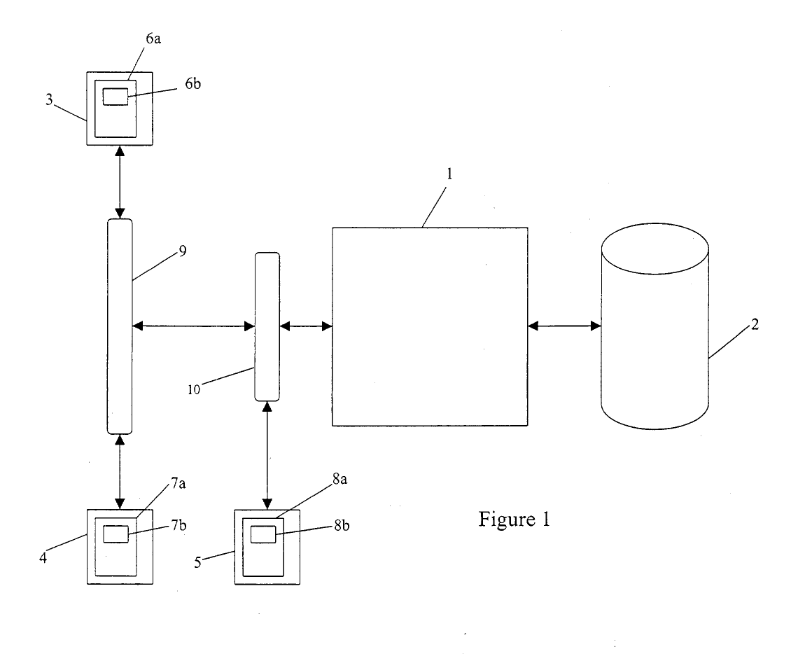

FIG. 1 shows an application server 1 to which is connected a database 2. A workstation 5 is connected to application server 1 via local area network (LAN) 10 which is also connected to the Internet 9 to which are connected two other workstations 3 and 4. Each workstation 3, 4, 5 executes browser software 6a, 7a, 8a. Browser software 6a, 7a, 8a establishes communication with application server 1 and downloads an applet 6b, 7b, 8b from the application server 1.

The applet 6b, 7b, 8b configures the browser software 6a, 7a, 8a such that it can transfer several objects consecutively between the database 2 and the workstation 3, 4, 5. This is useful since by requesting access of an object from the database 2, all functionally related objects can be consecutively downloaded.

It may be that not all of these functionally related objects require modification and so the applet 6b, 7b, 8b only uploads to the database 2 those objects which have been modified. The manner in which this is achieved will be described later.

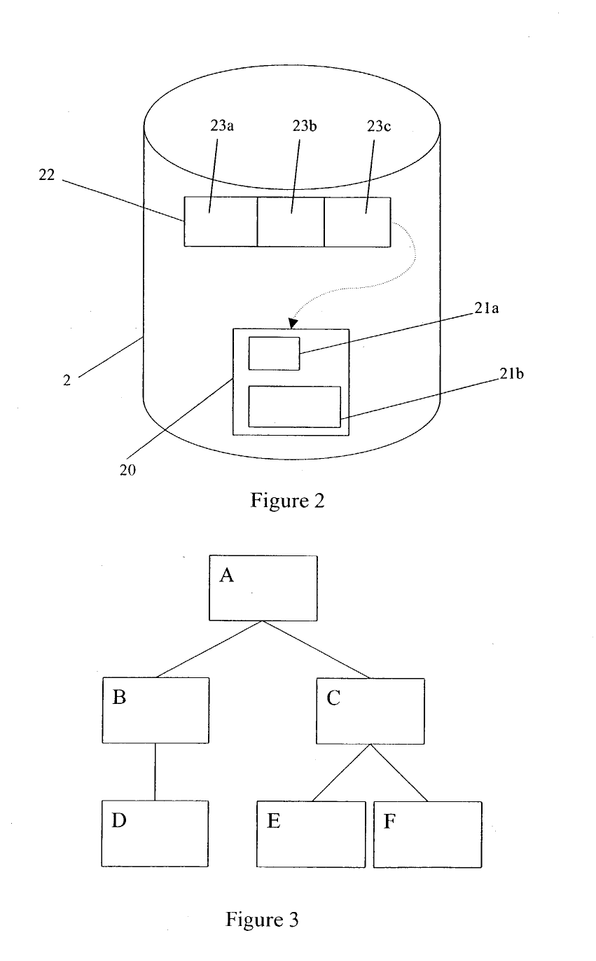

The objects may be stored on the database 2 in any of a variety of ways such as the method illustrated in FIG. 2. This shows an object 20 stored on database 2. Object 20 represents a source code file and has a header 21a and a body 21b. The header 21a lists other objects which are to be included in the source code when it is compiled and it is these objects on which object 20 is dependent. By extracting header 21a from object 20, application server 1 can generate a dependency matrix of objects and an example of this is shown in FIG. 3.

Also shown in FIG. 2 is a portion 22 of an object location table. This is used by the database 2 to locate object 20 and it also contains a size attribute 23a, a date attribute 23b and a time attribute 23c which indicate the size of the object in bytes and the date and time that it was last modified respectively. The portion 22 of the object location table also contains a field 23d, 23e, 23f holding the details of each user or service that has accessed object 20.

An example of a dependency matrix of objects representing source code files is shown in FIG. 3. In this example object A depends on objects B, C and F. Object B depends on objects D and E and object C depends on objects E and F. Furthermore, objects C and E are functionally related. In this example, workstation 3 requests access to object A from application server 1 using browser software 6a and applet 6b. Application server 1 then retrieves object A from database 2, extracts the dependency data from within object A thereby determining that it depends on objects B to F and downloads object A to workstation 3. Subsequently, workstation 4 requests object D and workstation 5 requests access to object C and these are downloaded to the relevant workstations using a similar process.

However, in the case of object C the applet software 8b determines that object E is functionally related to object C and hence, object E is also requested from application server 1 and downloaded to workstation 5.

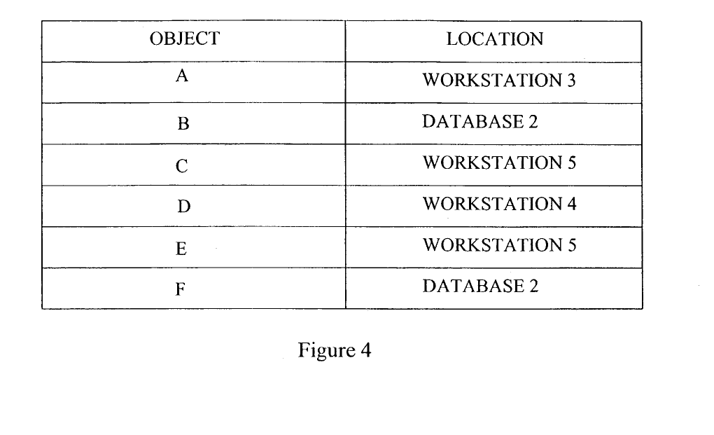

Application server 1 maintains a register linking each object with its location. The register for this example is shown in FIG. 4, in which it can be seen that the register indicates that object A is located at workstation 3, objects B and F are located on the database 2 (indicating that they have not been accessed), objects C and E are located on workstation 5 and object D is located on workstation 4. It is important to realise that a copy of each object is retained on database 2 and a new version of each object is stored on database 2 when the objects are uploaded from the workstations 3, 4, 5 to database 2. A history of the object is thus maintained.

Since workstation 3 downloaded object A prior to workstation 4 downloading object D and workstation 5 downloading objects C and E, workstation 3 will be notified that these objects C to E have been downloaded since application server 1 will determine that objects on which object A is dependent have been downloaded by other workstations. Application server 1 does this by sending a message to workstation 3 indicating that workstation 4 has downloaded object D and workstation 5 has downloaded objects C and E. If workstation 3 now downloads object F, the application server 1 will determine that object C depends on this and will send a message to workstation 5 indicating that object F has been downloaded by workstation 3.

Similarly, if after object D has been modified it is uploaded via application server 1 to database 2, then application server 1 can determine, from the dependency data that workstation 3 is accessing object C which depends on object D. A message indicating that object D has been modified will be sent to workstation 3.

In the case of uploading objects C and E to database 2, the applet 8b will compare the size, date and time attributes of objects C and E with those of the copies of objects C and E retained on database 2 and will only upload each object if any of its attributes have changed in value. In this way, the uploading of objects which have not been modified can be prevented.

It is important to note that while the present invention has been described in the context of a functioning data processing system, those of ordinary skill in the art will appreciate that the processes of the present invention are capable of being distributed in the form of a computer readable medium with instructions and a variety of forms and that the present invention applies equally regardless of a particular type of signal bearing media actually used to carry out the distribution. Examples of computer readable media include recordable type media such as floppy disc, a hard disc drive, RAM and CD-ROMs as well as transmission-type media, such as digital and analogue communications links.

We claim:

1. A project management system comprising a database for storing objects relating to a project together with data defining interdependencies of the objects; and a control system responsive to entities connected to it to provide access to selected objects stored on the database and to store on the database updated versions of selected objects received from the entities characterised in that the control system is adapted to notify, in response to an activity on an object, all entities handling that object or other objects dependent on that object of the existence of the activity.

2. A project management system according to claim 1, wherein the entities are workstations, users or services.

3. A project management system according to claim 1, wherein the activity comprises one or more of:
a. accessing the object; or
b. storing an updated version of the object.

4. A project management system according to claim 1, wherein the data defining interdependencies of the objects are stored with the objects themselves.

5. A project management system according to claim 1, wherein the control system maintains a register linking the objects with the entities handling them.

6. A project management system according to claim 1, wherein the control system can prevent access to certain objects.

7. A project management system according to claim 6, wherein the control system prevents access to objects that have been accessed and for which updated versions have not yet been stored on the database.

8. A project management system according to claims 1, wherein the control system is an application server.

9. A project management system according to claim 1, wherein the entities are connected to the control system via a network.

10. A project management system according to claim 9, wherein the network is the Internet.

11. A project management system according to claim 9, wherein the entity communicates with the control system using browser software.

12. A project management system according to claim 11, wherein the browser software is configured to transfer several objects consecutively between the database and the entity.

13. A project management system according to claim 12, wherein the browser software is configured to transfer several objects consecutively between the database and the entity using an applet downloaded from the control system.

14. A project management system according to claim 12, wherein the objects are transferred using the File Transfer Protocol (FTP) or the Hypertext Transfer Protocol (HTTP).

15. A project management system according to claim 12, wherein the objects have a size attribute indicating their size in bytes, a date attribute indicating the date that they were last modified, a time attribute indicating the time of day that they were last modified and a user or service attribute indicating the user or service who last accessed them.

16. A project management system according to claim 15, wherein an object previously transferred from the database to the entity is only transferred back to the database if one or more of the size, date or time attributes of the object differ from those of a copy of the object stored in the database.

17. A project management system according to claim 12, wherein the browser software is further configured, upon transfer of an object from the entity to the database, to extract from the object the data defining interdependencies of the objects and display a message on the entity requesting missing objects if there are any.

18. A project management system according to claim 17, wherein the browser software is configured to transfer several objects consecutively between the database and the entity using an applet downloaded from the control system and, upon transfer of an object from the entity to the database, to extract the data defining interdependencies of the objects from the object and display a message on the entity requesting missing objects if there are any by the applet downloaded from the control system.

19. A project management method comprising storing, on a database, objects relating to a project together with data defining interdependencies of the objects; responding to entities connected to a control system to provide access to selected objects stored on the database and to store on the database updated versions of selected objects received from the entities characterised in that, in response to an activity on an object, all entities handling that object or other objects dependent on that object are notified of the existence of the activity.

20. A method according to claim 19, wherein the activity comprises one or more of:
a. accessing the object; or
b. storing an updated version of the object.

21. A method according to either of the preceding claims, further comprising extracting the data defining the interdependencies of the objects from the objects themselves.

22. A method according to claim 19, wherein access is prevented to objects that have been accessed and for which updated versions have not yet been stored on the database.

23. A method according to claim 19, wherein several objects are transferred consecutively between the database and the entity.

24. A method according to claim 23, wherein an object previously transferred from the database to the entity is only transferred back to the database if one or more of the size, date of modification or time of modification differ from those of a copy of the object stored in the database.

25. A method according to claim 24, wherein the size, date of modification and time of modification of the object are determined by reading size, date and time attributes of the object.

26. A computer program comprising computer program code means adapted to perform all the steps of claim 19 when said program is run on a computer.

27. A computer program product comprising program code means stored on a computer readable medium for performing the method of claim 19 when said program product is run on a computer.
